(19) United States
(12) Patent Application Publication
(10) Pub. No.: US 2003/0021433 A1
(43) Pub. Date: Jan. 30, 2003

(54) Speaker configuration and signal processor for stereo sound reproduction for vehicle and vehicle having the same

(76) Inventor: Kyung Lak Lee, Seoul (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/916,341

(22) Filed: Jul. 30, 2001

(51) Int. Cl. H04R 5/02; H04B 1/00

(52) U.S. Cl. 381/302; 381/300; 381/86

(57) ABSTRACT

Disclosed are a speaker configuration and a signal processor for stereo sound reproduction for vehicle and a vehicle having the same that can provide all of the passengers with a left-right balanced stereo sound in a vehicle. The object of the invention is to provide a balanced stereo sound to all passengers in a vehicle. According to the invention to obtain the object, a speaker configuration for stereo sound reproduction in a vehicle which has a plurality of speakers installed therein, the speaker configuration comprises a first speaker provided in the left of a front central part of the vehicle for receiving a right channel output; and a second speaker provided in the right of the front central part of the vehicle for receiving a left channel output.

### BACKGROUND OF THE INVENTION

1. Field of the Invention

The present invention relates to a speaker configuration and a signal processor for stereo sound reproduction for vehicle and a vehicle having the same, in particular, which can provide all of the passengers with left-right balanced stereo sound in a vehicle.

2. Description of the Related Art

FIGS. 1A and 1B show arrangements for stereo sound listening environment using a stereo speaker set.

As shown in FIG. 1A, when sounds of same volume are emitted through two speakers 11 and 12 that are equally distanced from a listener, the listener who is in a sweet spot region (that is, the optimum listening position) may feel as if a sound source 13 is positioned at a center point between speakers 11 and 12. If one of the speakers 11 and 12 is closer to a listener's position that is out of sweet spot, the sound source 13 will be felt as biased thereto as shown in FIG 1B. Therefore, a listener positioned at the same distance from the stereo speakers 11 and 12 can feel left-right balanced stereo sound on the line connecting between the speakers. However, if there are a number of listeners in a certain area, the balanced stereo sound can be heard to only one(s) positioned at a vertex of an isoceles triangle opposed to the base of the triangle or along the line equidistant from the two speakers 11 and 12 (sweet spot region), and other listeners feel the sound biased toward a speaker nearer to them.

FIG. 2 shows an arrangement for stereo sound reproduction using a multi-channel speaker set of the prior art in a car.

Referring to a speaker arrangement of a car audio of the prior art as shown in FIG. 2, a driver and passengers are not positioned in the center even if a number of speakers (6 to 11) are provided. Therefore, the listeners cannot feel the balanced stereo sound since they are not positioned at the equidistant point from left and right speakers. Also, stereo signals are generated for optimal reproduction through the right and left speakers which are arranged at ±30° from the front direction of the listener, whereas the current speaker arrangement of the car audio as in FIG. 2 simultaneously reproduces these stereo signals through front and rear speakers in left and right sides which are asymmetrically arranged to all of the listeners so that nobody can feel the balanced stereo sound which can be felt in FIG. 1A. Therefore, there is a problem that no listeners in the car can be provided with the balanced stereo sound since such a speaker arrangement of the car audio of the prior art simultaneously reproduces the stereo sounds from the front and rear sides to all of the listeners who are not in the center position.

FIG. 3A and FIG. 3B are conceptual views of signal delay for providing a stereo sound to one person in a deluxe car of the prior art.

Here, the concept of signal delay is implemented to provide the stereo sound to only one person such as a driver or an honored passenger. For ideal stereo hearing, all speakers are required to be equally distanced from the listener. Therefore, a circle is drawn with the listener as the center and the distance to the farthest speaker as the radius, and then input signals from all speakers nearer to the listeners than the farthest speaker are delayed so that the input signals can be recognized as generated from virtual positions on the circumference of the circle. However, as a problem, this technology is restricted for only one listener since delay values cannot be determined for more than one listener.

The indoor sound listening environment of the vehicle is very inferior in the aspects of reverberation time and frequency characteristics since sound absorption materials such as a sheet, reflecting materials such as a window and various accessories are arranged in a limited space different from a general auditorium. Therefore, a reverberation signal processing is essential to improve such an environment. In order to obtain reverberation effect as can be actually heard in a hall, the sounds from front speakers are necessarily added with early reflections generated from the nearby walls of stage and the sounds from rear speakers are necessarily added with a later reverberations generated from the rearward walls of the hall. However, the current sound reproduction system of the car audio of the prior art is added with the same reverberation signal for all speaker channels.

### SUMMARY OF THE INVENTION

The present invention has been proposed to solve the foregoing problems of the prior art and it is therefore an object of the present invention to provide a left-right balanced stereo sound to all passengers in a vehicle.

According to the first aspect of the invention to obtain the object, it is provided a speaker configuration for stereo sound reproduction in a vehicle which has a plurality of speakers installed therein, the speaker configuration comprising: a first speaker provided in the left of a front central part of the vehicle for feeding a right channel output; and a second speaker provided in the right of the front central part of the vehicle for feeding a left channel output.

In the speaker configuration for stereo sound reproduction according to the second aspect of the invention, the first speaker and the speaker are arranged at the height within ±50 cm from the hight of the speakers previously installed in the vehicle.

In the speaker configuration for stereo sound reproduction according to the third aspect of the invention, each of the first and second speakers is a full-range speaker for reproducing both of low-frequency and high-frequency sounds.

In the speaker configuration for stereo sound reproduction according to the fourth aspect of the invention, each of the first and second speakers is a two-way speaker that is separated into a low-frequency speaker and a high-frequency speaker.

In the speaker configuration for stereo sound reproduction according to the fifth aspect of the invention, each of the first and second speakers is a coaxial speaker that is separated into a low-frequency speaker and a high-frequency speaker, which are coaxially bound.

In the speaker configuration for stereo sound reproduction according to the sixth aspect of the invention, each of the first and second speakers is a high-frequency speaker (tweeter).

In the speaker configuration for stereo sound reproduction according to the seventh aspect of the invention, the first speaker is oriented toward a left side of front seat in the vehicle, and the second speaker is oriented toward a right side of front seat in the vehicle.

According to the eighth aspect of the invention to obtain the object, it is provided a signal processor for stereo sound reproduction, in a vehicle which has a plurality of speakers and a head unit with built-in amplifiers (hereinafter will be referred to as powered head unit) installed therein, in use for a speaker configuration including a first speaker provided in the left of a front central part of the vehicle for feeding a right channel output and a second speaker provided in the right of the front central part of the vehicle for feeding a left channel output, the signal processor comprising: an equalizer for compensating the frequency characteristics of a front left channel output and a front right channel output supplied from the powered head unit according to the front speaker configuration in the vehicle and the vehicle type; and a terminal for distributing the left channel outputs as many as the front speakers for the left side and distributing the right channel outputs as many as the front speakers for the right.

The signal processor for stereo sound reproduction according to the ninth aspect of the invention further comprises a low-frequency pass filter for passing low-frequency components of a rear left channel output and a rear right channel output supplied from the powered head unit while performing a heavy damping in frequency bands beyond the range of the low-frequency components and outputting the left channel sound via the rear speaker for the left side and outputting the right channel sound via the rear speaker for the right side.

In the signal processor for stereo sound reproduction according to the tenth aspect of the invention, the low-frequency pass filter passes low-frequency components in the range of 80 to 1000 Hz while performing a heavy damping in frequency bands beyond the low-frequency range.

According to the eleventh aspect of the invention to obtain the object, it is provided a signal processor for stereo sound reproduction, in a vehicle which has a plurality of speakers and a head unit without power amplifier (hereinafter will be referred to as non-powered head unit) installed therein, for a speaker configuration including a first speaker provided in the left of a front central part of the vehicle for feeding a right channel signal; and a second speaker provided in the right of the front central part of the vehicle for feeding a left channel signal, the signal processor comprising: an early reflection sound processing unit for adding early reflections on a front left channel signal and a front right channel signal inputted from the non-powered head unit; an equalizer for compensating the tone of output signals from the early reflection sound processing unit according to the front speaker configuration in the vehicle and the vehicle type; and a first volume controller for controlling the volume of output signals from the equalizer, and distributing the left channel signal as many as the front speakers for the left side and distributing the right channel signal as many as the front speakers for the right side to feed the respective signals to amplifiers for front speakers.

In the signal processor for stereo sound reproduction according to the twelfth aspect of the invention, the early reflection processing unit adds 0 to 20 number of early reflections.

The signal processor for stereo sound reproduction according to the thirteenth aspect of the invention further comprises a first delay unit for delaying the left channel signal and the right channel signal inputted from the non-powered head unit for a certain period of time to remove the localization of a rear sound image; a later reverberation processing unit for adding later reflections to the output signals of the first delay unit; a first low-frequency pass filter for passing low frequency components of the signals reverberated from the later reverberation processing unit while performing a heavy damping in frequency bands beyond the range of the low-frequency components; and a second volume controller for controlling the volume of the output signals from the first low-frequency pass filter to feed the respective signals to amplifiers for rear speakers.

In the signal processor for stereo sound reproduction according to the fourteenth aspect of the invention, the first delay unit delays the signals for a time period of 0 to 10 milliseconds.

In the signal processor for stereo sound reproduction according to the fifteenth aspect of the invention, the later reverberation processing unit adds the later reverberations for 0 to 3 seconds.

In the signal processor for stereo sound reproduction according to the sixteenth aspect of the invention, the first low-frequency pass filter passes the low-frequency components in the range of 80 to 1000 Hz while performing a heavy damping in frequency bands beyond the low-frequency range.

The signal processor for stereo sound reproduction according to the seventeenth aspect of the invention further comprises a second delay unit for delaying a combined signal of the left channel signal and the right channel signal from the non-powered head unit to remove the localization of the rear sound image; a second low-frequency pass filter for passing low-frequency components of an output signal from the second delay unit while performing a heavy damping in frequency bands beyond the range of the low-frequency components; and a third volume controller for controlling the volume of an output signal from the second low-frequency pass filter to feed the signal to a sub-woofer amplifier.

In the signal processor for stereo sound reproduction according to the eighteenth aspect of the invention, the second delay unit delays the combined signal for a time period of 0 to 10 milliseconds.

In the signal processor for stereo sound reproduction according to the nineteenth aspect of the invention, the second low-frequency pass filter passes low-frequency components in the range the same as or lower than 80 Hz while performing a heavy damping in frequency bands beyond the low-frequency range.

According to the twentieth aspect of the invention to obtain the object, it is provided a vehicle having a dashboard installed with a plurality of speakers, comprising: a first speaker installed in a central left part of the dashboard of the vehicle for feeding a right channel output; and a second speaker installed in a central right part of the dashboard of the vehicle for feeding a left channel output.

### BRIEF DESCRIPTION OF THE DRAWINGS

In the accompanying drawings:

FIG. 1A shows left-right balanced stereo sound listening region using a stereo speaker set;

FIG. 1B shows left-right unbalanced stereo sound listening region using a stereo speaker set;

FIG. 2 shows speakers configuration for stereo sound reproduction using a multi-channel speaker set of the prior art in a car;

FIG. 3A and FIG. 3B are conceptual views of signal delay for providing a stereo sound to one person in a deluxe car of the prior art;

FIG. 4A is a conceptual view for showing the indoor sound reproduction;

FIG. 4B illustrates a variation of the magnitude of early reflections and later reverberations on time axis;

FIG. 5 shows a speaker configuration for vehicle according to the first embodiment of the invention;

FIG. 6 shows a speaker configuration for vehicle according to the second embodiment of the invention;

FIG. 7 shows a speaker configuration for vehicle according to the third embodiment of the invention;

FIG. 8 shows a block diagram of a signal processor for vehicle according to the fourth embodiment of the invention;

FIG. 9 shows a block diagram of a signal processor for vehicle according to the fifth embodiment of the invention; and

FIG. 10 shows a general view in which a varied example of the first embodiment and the fifth embodiment of the invention are combined.

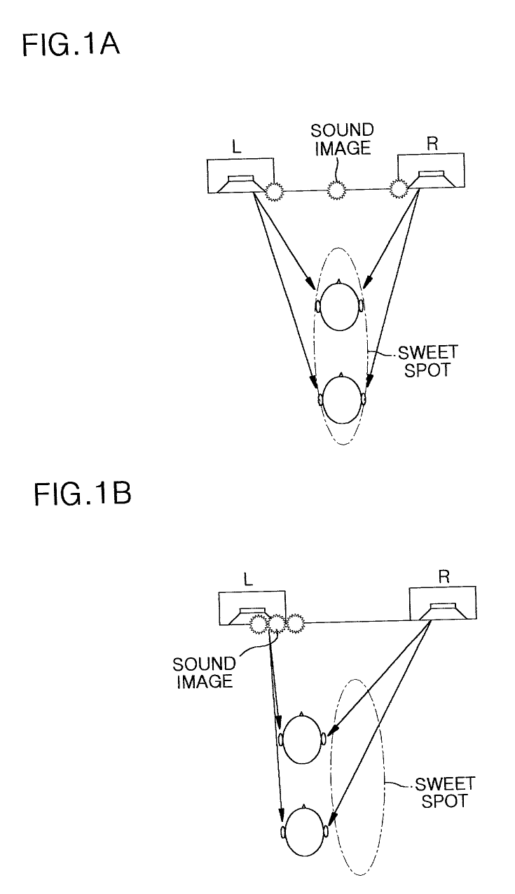

### DETAILED DESCRIPTION OF THE PREFERRED EMBODIMENT

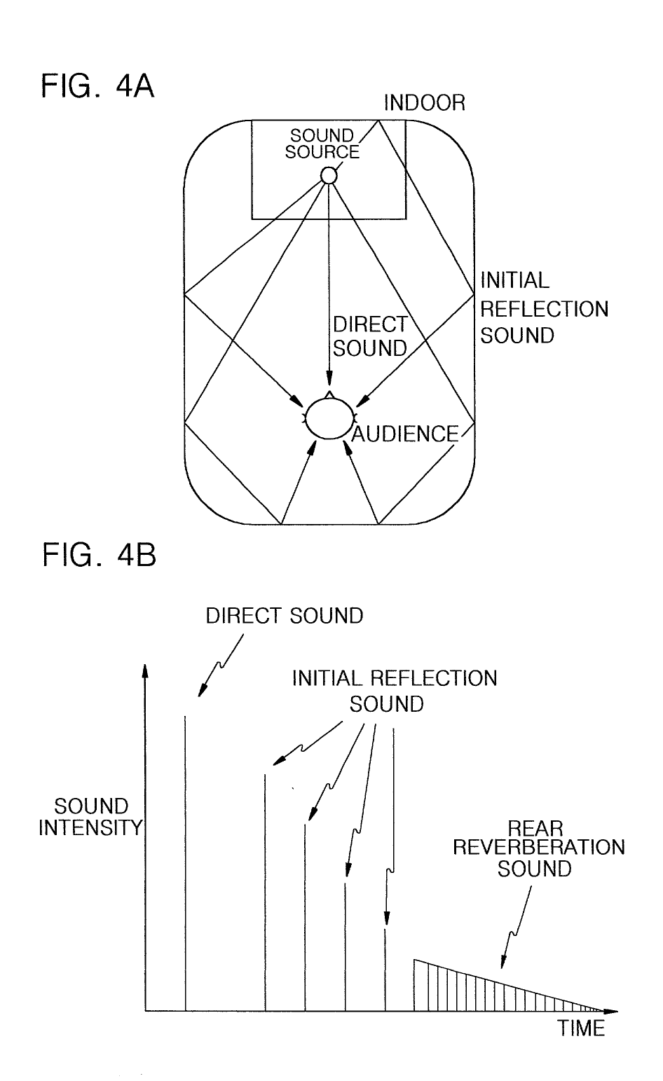

FIG. 4A is a conceptual view for showing the indoor sound reproduction, and FIG. 4B illustrates earlier reflections and later reverberations. In order to obtain reverberation effect the same as can be actually heard in a hall, front speakers in a front part of a vehicle are to be applied with the early reflections which are actually generated from the nearby walls of stage and rear speakers in a rear part of the vehicle are to be applied with the later reverberations which are actually generated from the rearward wall of the hall. Then passengers in the vehicle can feel the sound as if they are listening in a hall.

Hereinafter detailed description will be made about preferred embodiments of the invention:

First Embodiment

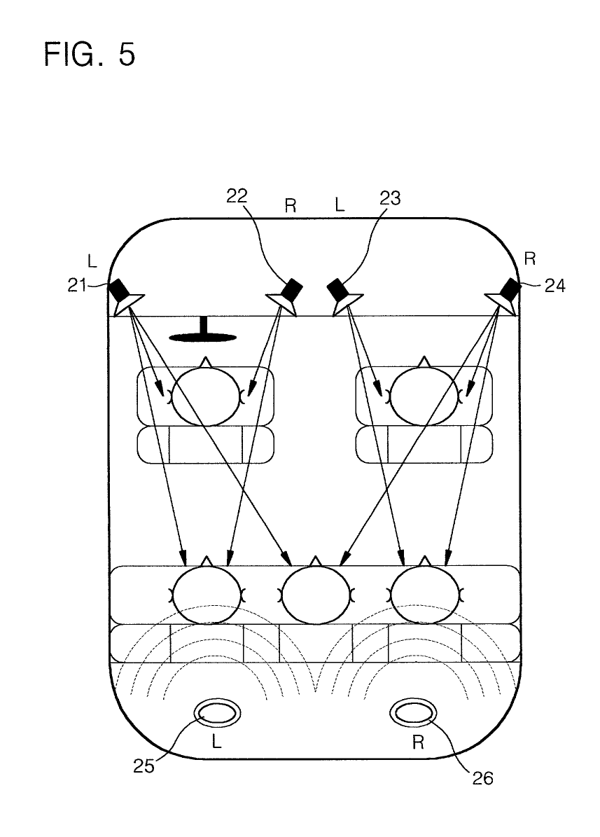

FIG. 5 shows a speaker configuration for vehicle according to the first embodiment of the invention.

The first left speaker 21 is installed in a front left part of a vehicle, the second right speaker 24 is installed in a front right part of the vehicle. The first left speaker 21 and the second right speaker 24 are previously arranged in a vehicle. Here, the first right speaker 22 and the second left speaker 23 are additionally installed in a front central part of the vehicle at the same height as the previously arranged speakers such as the first left speaker 21 and the second right speaker 24. The first right speaker 22 and the second left speaker 23 are full-range speakers. Also, each of the speakers 21, 22, 23 and 24 is installed with a predetermined orientation, in which the first left speaker 21 and the first right speaker 22 are oriented toward the left side of rear seat and the second left speaker 23 and the second right speaker 24 are oriented toward the right side of rear seat.

The first left speaker 21 and the second left speaker 23 receive a left channel output L which is added with the earlier reflections, the first right speaker 22 and the second right speaker 24 receive a right channel output R added with the earlier reflections. Therefore, each of the passengers receives the right and left stereo sounds at the same time since a set of the first right speaker 22 and the second left speaker 23 are installed in the front central part.

The first rear speaker 25 and the second rear speaker 26 are previously arranged in the vehicle, and adapted to enhance front stereo stage effect. In the first embodiment, the first rear speaker 25 and the second rear speaker 26 are used as woofers. The first rear speaker 25 is installed behind the left rear seat, and the second rear speaker 26 is installed behind the right rear seat. Delay units are used to delay sound signals before being inputted into the first rear speaker 25 and the second rear speaker 26 so that the first and second rear speakers 25 and 26 output the delayed left and right stereo signals to prevent side effect that a rear sound image is localized. Also, the later reverberations are added and a low-pass filtering and a reverberation processing are carried out for the output via the first and second rear speakers 25 and 26. Then, dynamic bass sound is reproduced to provide the surround feelings as that can be felt in the theater.

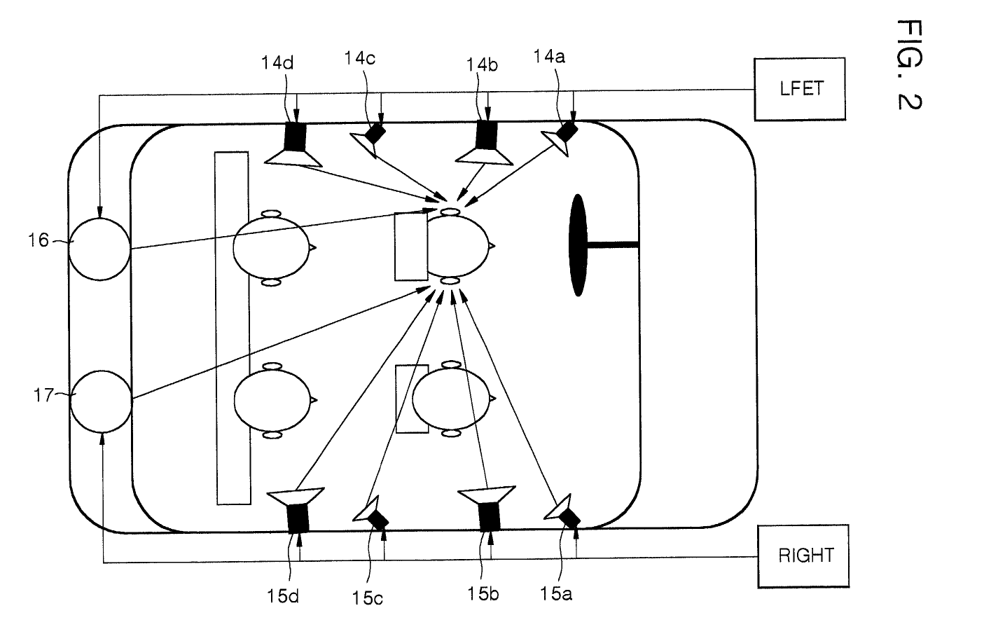

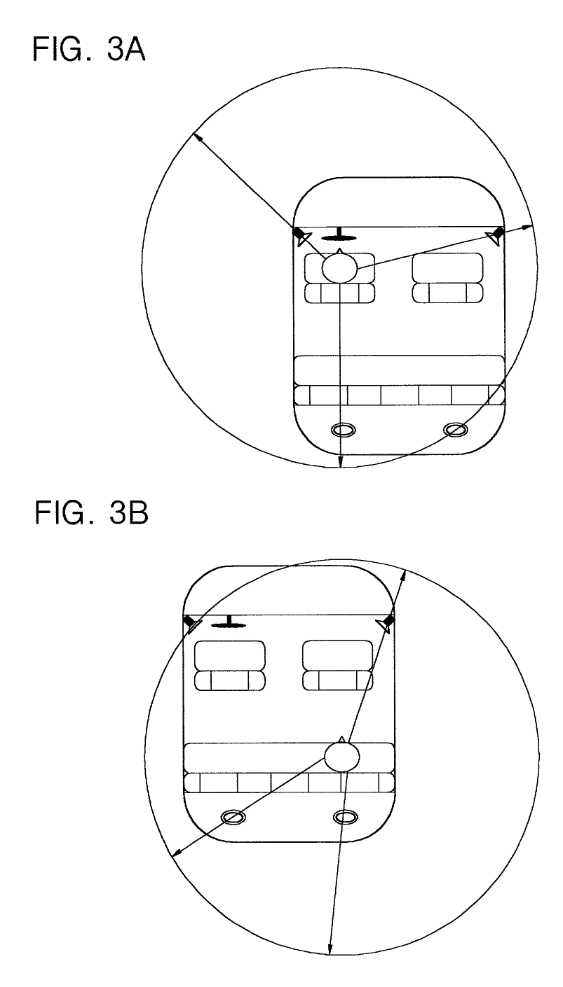

Therefore, the first embodiment provides a left-right balanced stereo sound to all of the passengers, i.e, the first embodiment can overcome the problem about stereo sound reproduction according to the speaker arrangement for vehicle of the prior art as in FIG. 2 and fundamentally solve lack of the stage-like stereophonic feeling due to the speaker arrangement and signal processing for vehicle of the prior art.

Second Embodiment

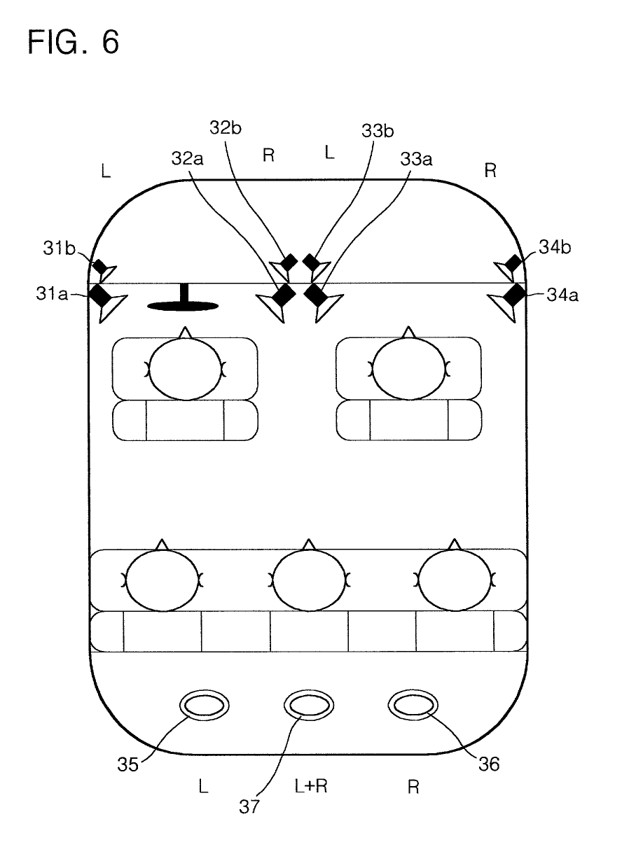

FIG. 6 shows a speaker configuration for vehicle according to the second embodiment of the invention.

The second embodiment is the same as the first embodiment in the basic concept except for using a two-way type speaker separated into a high-frequency speaker and a low-frequency speaker or a coaxial speaker separated into a high-frequency speaker and a low-frequency speaker which are manufactured as coaxially bound. The first low-frequency speaker 31a and the first left high-frequency speaker 31b are installed in a front left part of a vehicle, and the second right low-frequency speaker 34a and the second right high-frequency speaker 34b are installed in a front right part of the vehicle. The first left low-frequency speaker 31a, the first left high-frequency speaker 31b, the second rig ht low-frequency speaker 34a and the second right high-frequency speaker 34b are previously arranged in the vehicle. Here, all of the first right low-frequency speaker 32a, the first right high-frequency speaker 32b, the second left low-frequency speaker 33a and the second left high-frequency speaker 33b are additionally installed in a front central part of the vehicle. The first right low-frequency speaker 32a and the second left low-frequency speaker 33a are respectively installed at the same height as some of the previously arranged speakers such as the first low-frequency speaker 31a and the second right frequency speaker 34a, and the first right high-frequency speaker 32b and the second left high-frequency speaker 33b are respectively installed at the same height as the other previously arranged speakers such as the first left high-frequency speaker 31b and the and the second right high-frequency speaker 34b. The first right low-frequency speaker 32a and the first right high-frequency speaker 32b constitute a two-way type speaker separated into a low-frequency speaker and a high-frequency speaker or a coaxial speaker separated into the high-frequency speaker and the lower frequency speaker manufactured as bound. Also, the second left low-frequency speaker 33a and the second left high-frequency speaker 33b compose the two-way type speaker separated into the low-frequency speaker and the high-frequency speaker or the coaxial speaker separated into the high-frequency speaker and the lower frequency speaker manufactured as bound. Each of the speakers 31a, 31b, 32a, 32b, 33a, 33b, 34a and 34b is adopted to have a predetermined orientation, in which the first left low-frequency speaker 31a, the first left high-frequency speaker 31b, the first right low-frequency speaker 32a and the first right high-frequency speaker 32b are oriented toward the left side of rear seat, and the second left low-frequency speaker 33a, the second left high-frequency speaker 33b, the second right low-frequency speaker 34a and the second right high-frequency speaker 34b are oriented toward the right side of rear seat.

The first left low-frequency speaker 31a, the first left high-frequency speaker 31b, the second left low-frequency speaker 33a and the second left high-frequency speaker 33b receive a left channel output L added with the earlier reflections, whereas the first right low-frequency speaker 32a, the first right high-frequency speaker 32b, the second right low-frequency speaker 34a and the second right high-frequency speaker 34b receive a right channel output R added with the earlier reflections. Since a set of the first right low-frequency speaker 32a, the first right high-frequency speaker 32b, the second left low-frequency speaker 33a and the second left high-frequency speaker 33b are installed in the front central part, each of the passengers receives the left-right balanced stereo sound at the same time.

The first rear speaker 35, the second rear speaker 36 and a sub-woofer 37 are previously arranged in the vehicle, and adapted to enhance front stereo stage effect. In the second embodiment, the first rear speaker 35 and the second rear speaker 36 are used as woofers and the rear speaker 37 are used as the sub-woofer. The first rear speaker 35 is installed behind the left rear seat in the vehicle. The second rear speaker 36 is installed behind the right rear seat in the vehicle. The sub-woofer 37 is installed behind the middle rear seat in the vehicle.

Here, sound signals are delayed via delay unit before being inputted into the first rear speaker 35, the second rear speaker 36 and the sub-woofer 37 so that the first rear speaker 35, the second rear speaker 36 and the sub-woofer 37 output the delayed left and right stereo sound signals to prevent side effect that a rear sound image is localized.

Also, the later reverberations are added and a low-pass filtering and a reverberation signal processing are carried out for the outputs to the first and second rear speakers 35 and 36 and a low-pass filtering carried out for the output to the sub-woofer 37. Then, dynamic bass sound is reproduced to provide the surround feelings as can be felt in the theater.

Therefore, the second embodiment provides a left-right balanced stereo sound to all of the passengers, i.e, the second embodiment can overcome the problem about stereo sound reproduction according to the speaker arrangement for vehicle of the prior art as in FIG. 2 and fundamentally solve lack of the stage-like stereophonic feeling due to the speaker arrangement and signal processing for vehicle of the prior art.

Third Embodiment

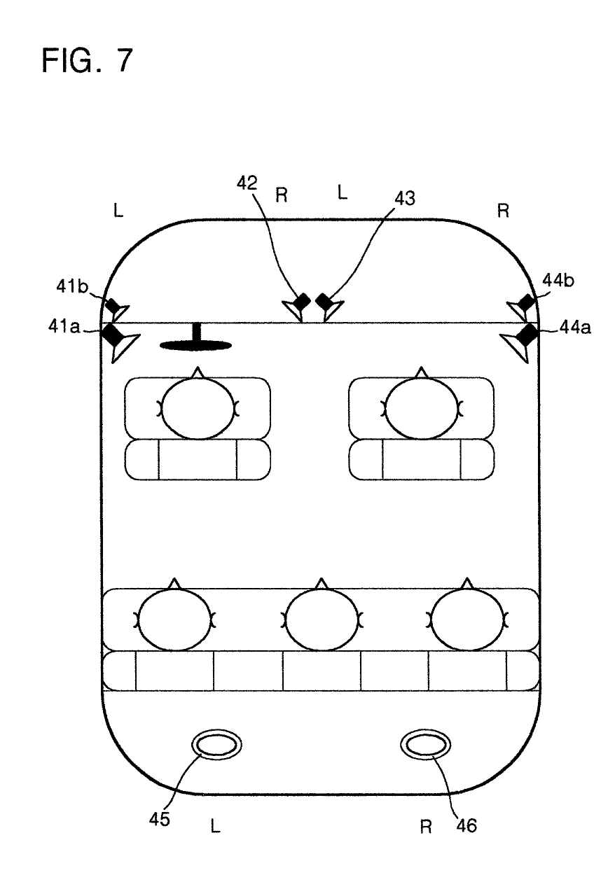

FIG. 7 shows a speaker arrangement for vehicle according to the third embodiment of the invention.

The third embodiment is the same as the second embodiment in the basic concept except for that only high-frequency speakers or tweeters 42 and 43 are used in a front central part of a vehicle on the basis that the human being uses a high-frequency band for finding an direction of sound. The first low-frequency speaker 41a and the first high-frequency speaker 41b are installed in a front left part of the vehicle, and the second right low-frequency speaker 44a and the second right high-frequency speaker 44b are installed in a front right part of the vehicle. The first left low-frequency speaker 41a, the first left high-frequency speaker 41b, the second right low-frequency speaker 44a and the second right high-frequency speaker 44b are previously arranged in the vehicle. Here, the first right tweeter 42 and the second left tweeter 43 are additionally installed in the front central part, and at the same height as the previously arranged speakers such as the first left high-frequency speaker 41b and the second right high-frequency speaker 44b. Both of the first right tweeter 42 and the second left tweeter 43 are high-frequency speakers for enhancing the orientation. Each of the speakers 41a, 41b, 42, 43, 44a and 44b is installed to have a predetermined orientation, in which the first left low-frequency speaker 41a and the first left high-frequency speaker 41b are oriented toward the left side of rear seat, and the first right tweeter 42 is oriented toward the left side of front seat, and the second left tweeter 43 is oriented toward the right side of front seat, and the second low-frequency speaker 44a and the second right high-frequency speaker 44b are oriented toward the right side of rear seat.

The first left low-frequency speaker 41a, the first left high-frequency speaker 41b and the second left tweeter 43 receive a left channel output added with the earlier reflections, whereas the first right tweeter 42, the second right low-frequency speaker 44a and the second right high-frequency speaker 44b receive a right channel output R added with the earlier reflections. Since a set of the first right tweeter 42 and the second left tweeter 43 are installed in the front central part, each of the passengers receives the left-right balanced stereo sound at the same time.

The first rear speaker 45 and the second rear speaker 46 are previously arranged in the vehicle, and adopted to enhance front stereo stage effect. In the third embodiment, the first rear speaker 45 and the second rear speaker 46 are used as woofers. The first rear speaker 45 is installed behind the left rear seat in the vehicle. The second rear speaker 46 is installed behind the right rear seat in the vehicle. Sound signals are delayed via delay unit before being inputted into the first rear speaker 45 and the second rear speaker 46 so that the first and second rear speakers 45 and 46 output the delayed left and right stereo signals to prevent side effect that a rear sound image is localized.

Also, the later reverberations are added and a low-pass filtering and a reverberation signal processing are carried out for the outputs to the first and second rear speakers 45 and 46, and a low-pass filtering carried out for the output to the sub-woofer 37. Then, dynamic bass sound is reproduced to provide the surround feelings as can be felt in the theater.

Therefore, the third embodiment provides a left-right balanced stereo sound to all of the passengers, i.e, the third embodiment can overcome the problem about stereo sound reproduction according to the speaker arrangement for vehicle of the prior art as in FIG. 2 and fundamentally solve lack of the stage-like stereophonic feeling due to the speaker arrangement and signal processing for vehicle of the prior art.

Fourth Embodiment

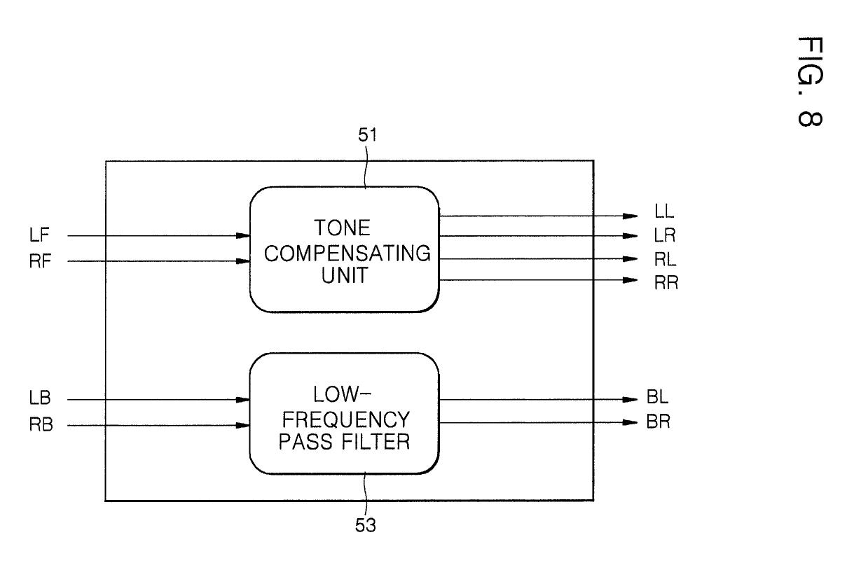

FIG. 8 shows a block diagram of a signal processor for vehicle according to the fourth embodiment of the invention.

The fourth embodiment is about the signal processor for providing a balanced stereo sound to all of the passengers. The signal processor is made of a passive device which receives, as an input, a large output signal amplified in an amplifier of a powered head unit. An equalizer 51 respectively receives a front left channel output LF and a front right channel output RF of the powered head unit to compensate the frequency characteristics according to the configuration of front speakers and vehicle type. The compensated outputs are fed to the front speakers after being separated into a left channel output LL of left side passenger, a right channel output LR of left side passenger, a left channel output RL of right side passenger and a right channel output RR of right side passenger. Here, the left channel output LL of left side passenger and the left channel output RL of right side passenger are the same ones, and the right channel output LR of left side passenger and the right channel output RR of right side passenger are the same ones.

A low-frequency pass filter 53 respectively receives a rear left output LB and a rear right output RB of the powered head unit, and then passes low-frequency components in the range of 80 to 1000 Hz while performing a heavy damping in frequency bands beyond the low-frequency range to reproduce dynamic bass sound. The outputs compensated like this are volume controlled in the second volume controller 54, and fed to rear speakers respectively.

Fifth Embodiment

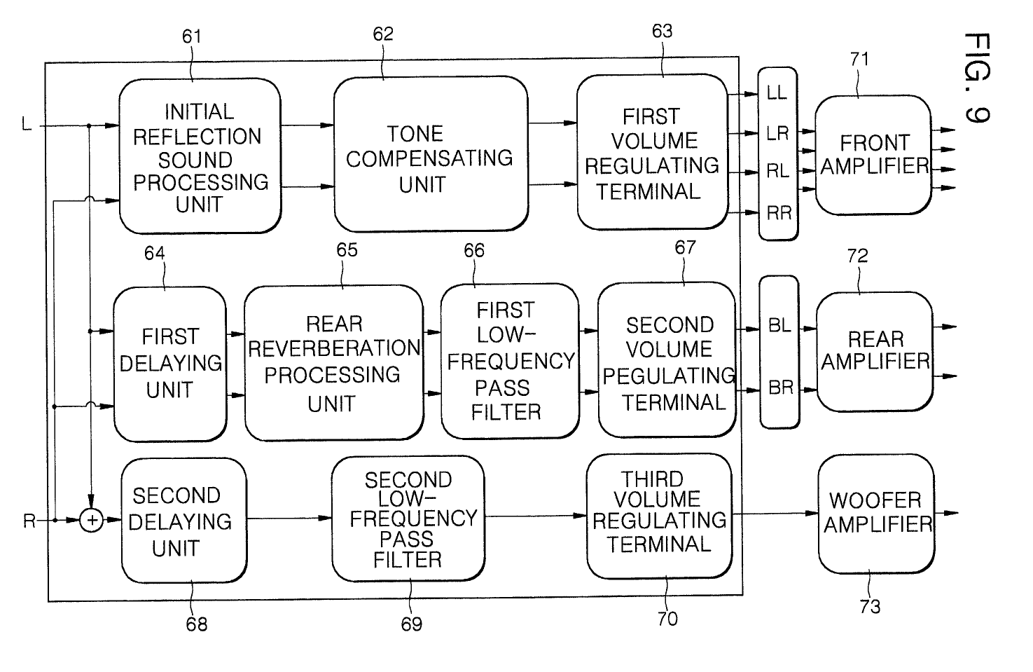

FIG. 9 shows a block diagram of a signal processor for vehicle according to the fifth embodiment of the invention.

The fifth embodiment is about the signal processor for vehicle for providing a left-right balanced stereo sound to all of the passengers. The signal processor is made of an active device for receiving a signal of a non-powered head unit. In order to compensate the indoor sound environment of a vehicle, an earlier reflection processing unit 61 receives a left channel signal L and a right channel signal R and processes the signals to add 0 to 20 number of earlier reflections. Description about the earlier reflections and the later reverberation will be omitted in this embodiment since they were explained in reference to FIG. 4A and FIG. 4B. The equalizer 62 respectively receives the left channel signal and the right channel signal, which are processed with the earlier reflections, and compensates the tone according to the configuration of front speakers and the vehicle type. The signals compensated like this are volume controlled, and fed to a front amplifier 71 after being separated into a left channel signal LL of left side passenger, a right channel signal LR of left side passenger, a left channel signal RL of right side passenger and a right channel signal RR of right side passenger. Here, the left channel signal LL of left side passenger and the left channel signal RL of right side passenger are the same signals, and the left channel signal RL of right side passenger and the right channel signal RR of right side passenger are the same signals.

The first delay unit 64 respectively receives the left channel signal L and the right channel signal R, and delays the signals for 0 to 10 milliseconds to remove the localization of the rear sound image. A later reverberation processing unit 65 receives the delayed signals, and reverberates by adding later reverberations for 0 to 3 seconds to provide the surround sound which can be felt in the theater. The first low-frequency pass filter 66 respectively receives the reverberated left and right signals, and passes low-frequency components in the range of 80 to 1000 Hz while performing a heavy damping in frequency bands beyond the low-frequency range to reproduce dynamic bass sound. The signals compensated like this are volume controlled in the second volume controller 67 and fed to a rear amplifier 72 after being separated into a rear left channel signal BL and a rear right channel signal BR. The second delay unit 68 receives a mono signal which is a combined signal of the left channel signal L and the right channel signal R, and delays the signal for a certain period of time ranging 0 to 10 milliseconds to remove the localization of the rear sound image. The second low-frequency pass filter 69 receives an output signal of the second delay unit 68, and passes low-frequency components in the range of the same as or lower than 80 Hz while performing a heavy damping in frequency bands beyond this range. Then, low-frequency is passed and high-frequency is damped for dynamic sub-woofer reproduction. The signal which is low-frequency processed like this is volume controlled in the third volume controller 70, and then fed to a sub-woofer amplifier 73.

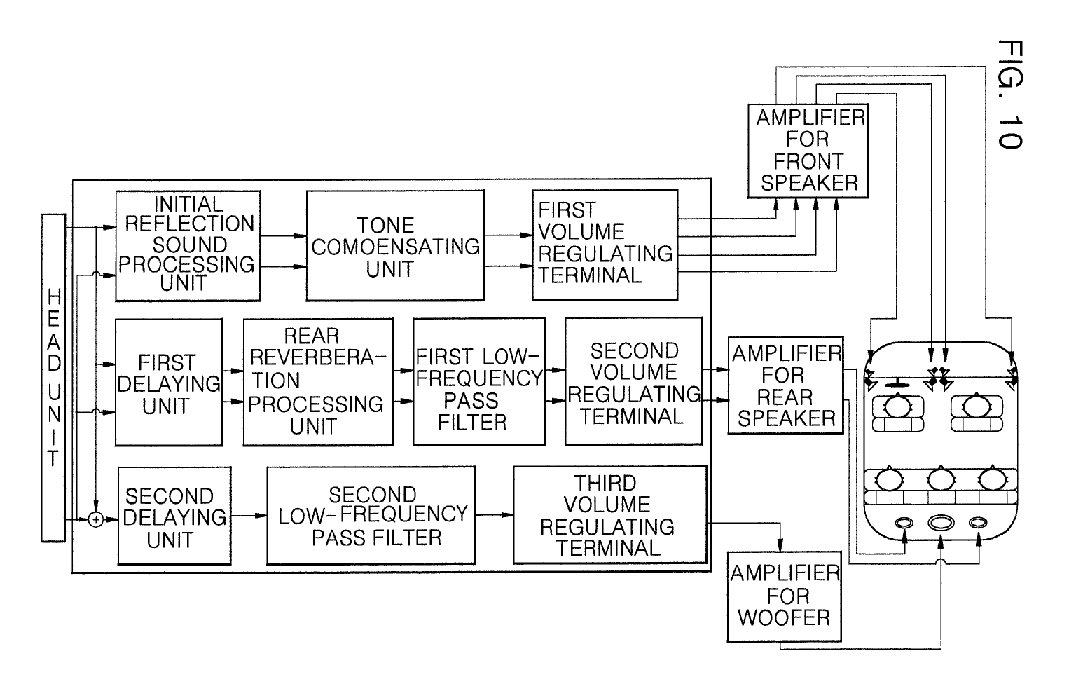

FIG. 10 shows a general view in which a varied example of the first embodiment and the fifth embodiment of the invention are combined.

Referring to FIG. 10, the varied first embodiment with a woofer being installed thereto is combined with the fifth embodiment. Description of each block has already made above, so explanation thereof will be omitted. As shown in FIG. 10, one of the first embodiment, the second embodiment, the third embodiment and a preferable variation thereof can be arbitrarily combined with one of the fourth embodiment, the fifth embodiment and a preferable variation thereof to constitute a stereo sound reproduction system for the whole vehicle.

Also, while it has been omitted in the drawings, the front speakers in the first, second and third embodiments can be provided as integrally mounted to a dashboard which will be installed in the vehicle later. Here, the first speaker is installed in a central left part of the dashboard to receive a right channel output, and the second speaker is installed in a central right part of the dashboard to receive a left channel output.

The present invention can provide all of the passengers with the balanced stereo sound which has not been able to be obtained in the vehicle of the prior art, in which the set of additional speakers are mounted while making the best of the previously arranged speakers to enable easy installation with low cost. For example, the fourth embodiment utilizes the head unit and the previously arranged speakers so that the embodiment can be performed with minimum cost and effort. The signal processor of the fourth or fifth embodiment can be installed into the head unit if designed as a single chip or module. If the speaker configuration proposed in the invention is applied at a designing stage of vehicle, a vehicle can be manufactured which provides the left-right balanced stereo sound for all passengers. According to the invention, the left and right speakers are placed at the same distance from each of the passengers to provide a correct stereo sound stage.

What is claimed is:

1. A speaker configuration for stereo sound reproduction in a vehicle which has a plurality of speakers installed therein, said speaker configuration comprising:
a first speaker provided in the left of a front central part of the vehicle for receiving a right channel output; and
a second speaker provided in the right of the front central part of the vehicle for receiving a left channel output.

2. A speaker configuration for stereo sound reproduction according to claim 1, wherein said first speaker and said speaker are arranged at the height within ±50 cm from the height of the speakers previously installed in the vehicle.

3. A speaker configuration for stereo sound reproduction according to claim 1, wherein each of said first and second speakers is a full-range speaker for reproducing both of low-frequency and high-frequency sounds.

4. A speaker configuration for stereo sound reproduction according to claim 1, wherein each of said first and second speakers is a two-way speaker which is separated into a low-frequency speaker and a high-frequency speaker.

5. A speaker configuration for stereo sound reproduction according to claim 1, wherein each of said first and second speakers is a coaxial speaker which is separated into a low-frequency speaker and a high-frequency speaker which are coaxially bound.

6. A speaker configuration for stereo sound reproduction according to claim 1, wherein each of said first and second speakers is a high-frequency speaker (tweeter).

7. A speaker configuration for stereo sound reproduction according to claim 6, wherein said first speaker is oriented toward a left front seat in the vehicle, and said second speaker is oriented toward a right front seat in the vehicle.

8. A signal processor for stereo sound reproduction, in a vehicle which has a plurality of speakers and a powered head unit installed therein, in use for a speaker configuration including a first speaker provided in the left of a front central part of the vehicle for receiving a right channel output and a second speaker provided in the right of the front central part of the vehicle for receiving a left channel output, said signal processor comprising:
an equalizer for compensating the frequency characteristics of a front left channel output and a front right channel output inputted from the powered head unit according to the front speaker configuration in the vehicle and the vehicle type and distributing the left channel outputs as many as the front speakers for the left side and distributing the right channel outputs as many as the front speakers for the right side.

9. A signal processor for stereo sound reproduction for vehicle according to claim 8, further comprising:
a low-frequency pass filter for passing low-frequency components of a rear left channel output and a rear right channel output inputted from the powered head unit while performing a heavy damping in frequency bands beyond the range of the low-frequency components.

10. A signal processor for stereo sound reproduction for vehicle according to claim 9, wherein said low-frequency pass filter passes low-frequency components in the range of 80 to 1000 Hz while performing a heavy damping in frequency bands beyond the low-frequency range.

11. A signal processor for stereo sound reproduction, in a vehicle which has a plurality of speakers and a non-powered head unit installed therein, for a speaker configuration including a first speaker provided in the left of a front central part of the vehicle for receiving a right channel signal; and a second speaker provided in the right of the front central part of the vehicle for receiving a left channel signal, said signal processor comprising:
an earlier reflection processing unit for adding earlier reflections to a left channel signal and a right channel signal inputted from the non-powered head unit;
an equalizer for compensating the tone of output signals from said earlier reflection processing unit according to the front speaker arrangement in the vehicle and the vehicle type; and
a first volume controller for controlling the volume of output signals from said tone compensating unit, and distributing the left channel signal as many as the front speakers for the left side and distributing the right channel signal as many as the front speakers for the right side to output respective signals to amplifiers for front speakers.

12. A signal processor for stereo sound reproduction for vehicle according to claim 11, wherein said earlier reflection processing unit adds 0 to 20 number of earlier reflections.

13. A signal processor for stereo sound reproduction for vehicle according to claim 11, further comprising:
a first delay unit for delaying the left channel signal and the right channel signal inputted from the non-powered head unit for a certain period of time to remove the localization of a rear sound image;
a later reverberation processing unit for adding later reverberations to the output signals of the first delay unit;
a first low-frequency pass filter for passing low frequency components of the signals reverberated from the later reverberation processing unit while performing a heavy damping in frequency bands beyond the range of the low-frequency components; and
a second volume controller for controlling the volume of the output signals from said first low-frequency pass filter to output the controlled signals to amplifiers for rear speakers.

14. A signal processor for stereo sound reproduction for vehicle according to claim 13, wherein said first delay unit delays the signals for a time period of 0 to 10 milliseconds.

15. A signal processor for stereo sound reproduction for vehicle according to claim 13, wherein said later reverberation processing unit adds the later reverberations for 0 to 3 seconds.

16. A signal processor for stereo sound reproduction for vehicle according to claim 13, wherein said first low-frequency pass filter passes the low-frequency components in the range of 80 to 1000 Hz while performing a heavy damping in frequency bands beyond the low-frequency range.

17. A signal processor for stereo sound reproduction for vehicle according to claim 16, further comprising:
a second delay unit for delaying a combined signal of the left channel signal and the right channel signal from the non-powered head unit to remove the localization of the rear sound image;
a second low-frequency pass filter for passing low-frequency components of an output signal from said second delay unit while performing a heavy damping in frequency bands beyond the range of the low-frequency components; and
a third volume controller for controlling the volume of an output signal from said second low-frequency pass filter to feed the signal to a sub-woofer amplifier.

18. A signal processor for stereo sound reproduction for vehicle according to claim 17, wherein said second delay unit delays the combined signal for a time period of 0 to 10 milliseconds.

19. A signal processor for stereo sound reproduction for vehicle according to claim 17, wherein said second low-frequency pass filter passes low-frequency components in the range the same as or lower than 80 Hz while performing a heavy damping in frequency bands beyond the low-frequency range.

20. A vehicle having a dashboard installed with a plurality of speakers, comprising:
a first speaker installed in a central left part of the dashboard of the vehicle for receiving a right channel output; and
a second speaker installed in a central right part of the dashboard of the vehicle for receiving a left channel output.
